(19) United States
(12) Patent Application Publication
(10) Pub. No.: US 2008/0186455 A1
(43) Pub. Date: Aug. 7, 2008

(54) DLP LAMP SAVER

(75) Inventor: Don Meier, Carmel, IN (US)

Correspondence Address: SHIMOKAJI & ASSOCIATES, P.C., 8911 RESEARCH DRIVE, IRVINE, CA, 92618, US

(73) Assignee: TTE TECHNOLOGY, INC., INDIANAPOLIS, IN (US)

(21) Appl. No.: 11/689,652

(22) Filed: Mar. 22, 2007

(30) Foreign Application Priority Data
Feb. 7, 2007 (CN) 200710073216.5

(51) Int. Cl. G03B 21/20

(52) U.S. Cl. 353/85

(57) ABSTRACT

A digital light processor (DLP) instrument, such as a DLP television, may include a timer for measuring a period of inactivity wherein, for example, a user of the television does not press buttons on either the television or the remote control. Once the period of inactivity reaches a predetermined, user defined time, a DLP lamp of the television may by shut off, while maintaining power to other components of the television, such as the main controller board and integrated television tuners.

### CROSS-REFERENCE TO RELATED APPLICATIONS

This application claims foreign priority under 35 USC 119(a)-(d) to Chinese Patent Application 200710073216.5, filed on Feb. 7, 2007, the disclosure of which is herein incorporated by reference in its entirety.

### BACKGROUND OF THE INVENTION

The present invention relates to an apparatus and method to preserve lamp life on a DLP instrument, and more specifically to allow for an energy conserving DLP television that may have a long DLP lamp life.

The digital light processing (DLP) technique has been developed by Texas Instrument since 1987. In a DLP projection system, an optical element called a digital micro-mirror device (DMD) is utilized. On the digital micro mirror device there are thousands of micro-mirrors for reflecting light beams onto a screen to form an image. Each of these micro-mirrors has an independent driving electrode, support post and steering shaft. When the DLP projection system is under a light state, light beams projected onto the micro-mirrors are reflected into a projection lens and then focused on a screen. When the DLP projection system is under a dark state, these micro-mirrors are driven by applying a voltage to the driving electrodes and tilted to a specific angle, so that light beams projected onto the mirrors are reflected in directions other than into the projection lens.

Referring to FIG. 1, there is shown a conventional DLP projection system 10. When the projection system 10 is under a light state, inhomogeneous light beams from a light source are first converted into homogeneous incident light beams 17 via an illumination device 11, and then enter a prism set 12. The light beams 17 are totally internal reflected onto micro-mirrors (not shown) on a DMD 13, reflected into a projection lens 14 by these micro-mirrors, and projected onto a screen 16. On the other hand, when the DLP projection system 10 is under a dark state, the micro-mirrors (not shown) on the DMD 13 deflect the incident light beams 17, so that the incident light beams 17 are deviated away from an optic axis of the projection lens 14 after passing through the prism set 12. To avoid unwanted light beams from entering the projection lens 14, a projection lens optical stop 15 is used for shielding deviation light beams 18 and stray light beams 19 coming from the light beams 17. In this DLP projection system 10, the design of the optical stop 15 is a crucial factor that affects contrast.

However, the conventional DLP projection system 10 has certain drawbacks. For example, one drawback of a conventional DLP projection system 10 is that the illumination device 11 may have to be periodically replaced by the consumer. While some consumers may be able to replace the illumination device 11 themselves, others may require a service call, thereby prolonging the downtime of the DLP projection system 10 and increasing the cost of the service.

A projection type display device is disclosed by Japanese Patent Application Publication 2001-133880A Nitta Keiichi. The Keiichi patent application describes a projection type display device that may shut down after a set period of time based on the lack of a signal received from one of a various number of inputs. However, when there is a signal in one of the inputs (including, for example, a memory card plugged therein), the lamp in the projection type display device may be continually lit.

As can be seen, there is a need for an apparatus and method for preserving the life of the illumination device in a DLP projection system while not adding to the cost or to the complexity of the unit.

### SUMMARY OF THE INVENTION

In one aspect of the present invention, a method for preserving lamp life of a digital light processing (DLP) instrument comprises measuring an inactivity time of the DLP instrument; comparing the inactivity time with a user defined time period; and turning off a lamp of the DLP instrument when the inactivity time reaches the user defined time period while maintaining power to the main controller board of the DLP instrument. The inactivity timer may be initiated when there is no IR or front panel key presses on the display device and may include motion detection devices in future display devices.

In another aspect of the present invention a method for controlling power to a digital light processor (DLP) lamp in a DLP television comprises turning off the DLP lamp when an inactivity time reaches a user defined time period while maintaining power to a main controller board of the DLP television; turning on the DLP lamp after activity of the DLP television is detected; and restarting the measurement of the inactivity time.

According to a further aspect of the present invention, a digital light processor (DLP) instrument comprises a main controller board; a DLP lamp; a timer to measure inactivity of the DLP instrument; a power supply providing continuous power to the main controller board, wherein the power supply turning off power to the DLP lamp when time measured by the timer reaches a user defined time.

These and other features, aspects and advantages of the present invention will become better understood with reference to the following drawings, description and claims.

### BRIEF DESCRIPTION OF THE DRAWINGS

FIG. 1 is a schematic view of a conventional digital light processing (DLP) projection system;

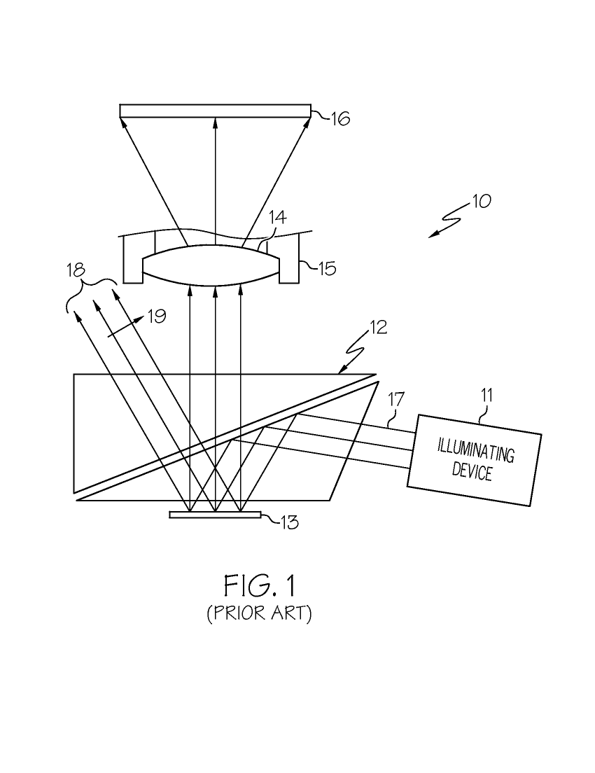

FIG. 2 is a schematic block diagram showing a DLP projection system according to the present invention; and

FIG. 3 is a flow chart describing a method according to one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The term “DLP instrument” as used herein refers to a device that uses digital light processing (DLP) technology to create an image. DLP instruments may include projectors, televisions and the like.

Briefly, the present invention provides an apparatus and method for preserving the lamp life of a DLP instrument, such as a DLP rear projection television. The DLP lamp may be a conventional DLP lamp as may be used in conventional DLP instruments. Conventional DLP televisions often require the consumer to change the DLP lamp of their DLP television after a set number of hours. If a conventional DLP television is left on unintentionally, the DLP lamp is continually lit to provide a picture, this set number of hours to DLP lamp replacement may occur more frequently when compared to DLP televisions that incorporate the apparatus and methods of the present invention. The present invention provides a DLP television that may shut down the DLP lamp after a set period of time, thereby saving lamp life and lengthening the time between required lamp changes by the consumer.

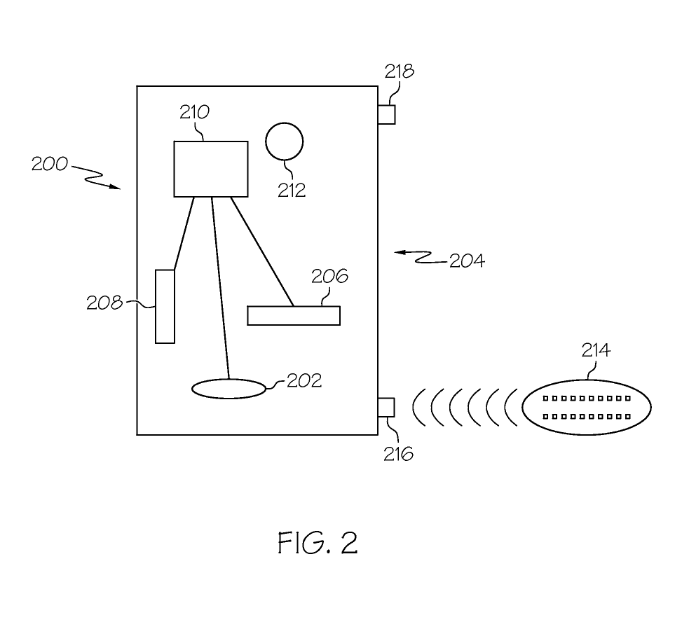

Referring to FIG. 2, there is shown a schematic drawing of a DLP instrument 200, such as a television, according to one embodiment of the present invention. The DLP television 200 may include a conventional DLP lamp 202 which may project an image onto a screen 204. A main controller board 206 may control the DLP lamp 202 and any accessories integrated with the television 200 (such as a DVD player, digital video recorder, or the like, not shown). The DLP television 200 may also include at least one tuner 208. A power supply 210 may supply power to the DLP lamp 202, the main controller board 206, and the tuner 208.

An inactivity timer 212 may be used to determine an inactivity time with respect to the DLP television 200. Inactivity may be determined, for example, by the lack of any buttons being depressed on a remote control 214, by the lack of any television front panel buttons 216 being depressed, or by the lack of any other interaction between a user and the television 200. Such inactivity may be an indicator that the television 200 has been left on inadvertently. The inactivity timer 212 may begin when the television is turned on and may reset whenever activity is detected with respect to the DLP television 200. The DLP television 200 may include a user programmable feature through which the inactivity timer 212 may be deactivated during certain periods of time. For example, the inactivity timer 212 may de deactivated during the day, for example, from 8 am through 8 pm. Activity may be determined, for example, by any button being depressed on the remote control 214, by any television front panel buttons 216 being depressed, or by any other interaction between a user and the television 200.

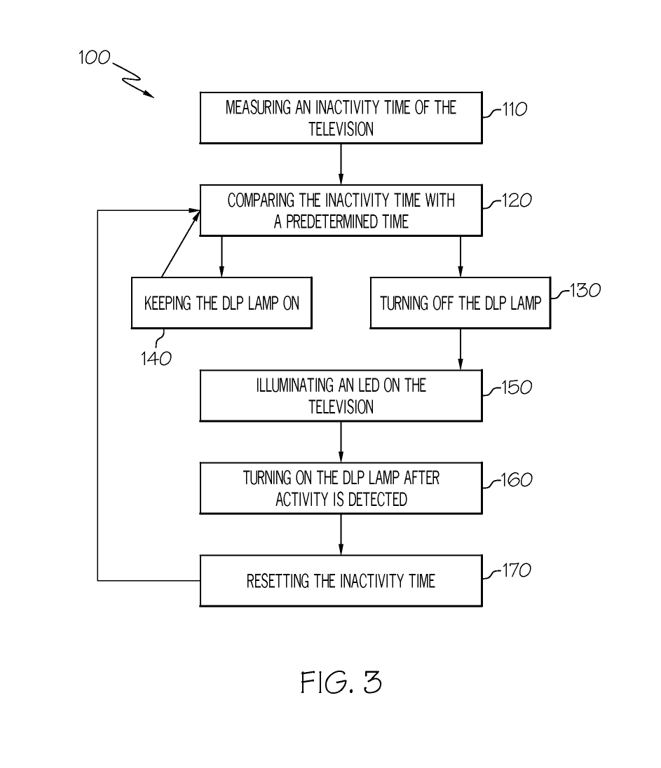

After a pre-programmed period of time prior to the inactivity timer expiring, such as from about three to about five minutes prior to the inactivity timer expiring, a clock symbol with a message such as “Inactivity timer about to expire, press any key to continue programming” may appear on the screen. When the inactivity timer 212 reaches a user defined time, power to the DLP lamp 202 may be turned off. Power may be maintained to the main controller board 206 as well as to the tuner 208. An LED 218 may be lit on the television 200 to indicate that the DLP lamp 202 has been turned off due to inactivity. Once activity is detected, power to the DLP lamp 202 may be restored and the inactivity timer 212 may be restarted. Further details of the operation of the present invention may be described below with respect to FIG. 3.

Referring to FIG. 3, there is shown a method 300 for preserving DLP lamp life. A step 310 includes measuring an inactivity time of a DLP instrument, such as a television. The television may include a conventional timer to measure the inactivity time. The timer may be started when the power to the television 200 is turned on. So long as there is inactivity with respect to the television 200, the timer may continue to run. Should activity be detected, the timer may reset and start from the beginning.

A step 320 may include comparing the inactivity measured in step 310 with a predetermined, user defined time period to determine whether the DLP lamp should be turned off or kept on. When the period of inactivity reaches the predetermined time period, the method may move to a step 330 of turning off the DLP lamp. The period of inactivity needed to turn off the DLP lamp may either be preset or may be selected by a user in, for example, a menu system of the television. The period of inactivity may be set, for example, from about 1 hour to about 24 hours. The DLP lamp may by turned off by turning off power to the DLP lamp (e.g., by supplying 0 W to the DLP lamp).

If the period of inactivity is less than the predetermined time period, the method may move to a step 340 of keeping the DLP lamp on and repeating steps 310 and 320 until the period of inactivity reaches the predetermined time period.

When the DLP lamp is turned off, the power supply may supply continuous power to the main controller board. Unlike conventional computer monitors which may shut down entirely either when the input signal is removed or when there is a period of inactivity, the present invention may only remove power to the DLP lamp, as opposed to the entire DLP instrument. Many DLP televisions include a television tuner integrated therein. By maintaining power to the main controller boards (including, for example, any tuners that may be a part of television), any recording devices (such as a digital video recorder) connected to the television may continue recording based on a signal received from the DLP-integrated television tuner.

After step 330, when the DLP lamp is turned off, a step 350 of illuminating an LED on the television may be used to alert a user that power to the DLP lamp has been turned off.

A step 360 of turning on the DLP lamp may occur after activity is detected. As discussed above, activity may be determined, for example, by any button being depressed on a remote control, by any television front panel buttons being depressed, or by any other interaction between a user and the television. The DLP lamp may be turned on by supplying power thereto via a power supply that is switchable between an on condition and an off condition. The amount of power may be determined by the manufacturer of the DLP lamp and may be, for example, 100 W or 120 W.

After the DLP lamp is turned back on, a step 370 of resetting the inactivity time may be used to restart counting the time of inactivity as the method may return to step 110.

It should be understood, of course, that the foregoing relates to exemplary embodiments of the invention and that modifications may be made without departing from the spirit and scope of the invention as set forth in the following claims.

We claim:

1. A method for preserving lamp life of a digital light processing (DLP) instrument, the method comprising:
measuring an inactivity time of the DLP instrument;
comparing the inactivity time with a user defined time period; and
turning off a lamp of the DLP instrument when the inactivity time reaches the user defined time period while maintaining power to a main controller board of the DLP instrument.

2. The method according to claim 1, further comprising providing an illumination on the DLP instrument when the lamp is turned off.

3. The method according to claim 1, further comprising:
turning on the lamp after activity of the DLP instrument is detected; and
restarting the measurement of the inactivity time.

4. The method according to claim 1, wherein the DLP instrument is a DLP television.

5. The method according to claim 1, wherein the user defined time period is up to about 24 hours.

6. The method according to claim 1, wherein the user defined time is set by a user of the DLP instrument.

7. The method according to claim 1, further comprising turning on the DLP lamp when activity is detected by the DLP instrument.

8. The method according to claim 1, wherein the inactivity timer is deactivated during a predetermined interval of time, thereby preventing the step of turning off the amp of the DLP instrument during this predetermined interval of time.

9. A method for controlling power to a digital light processor (DLP) lamp in a DLP television, the method comprising:
turning off the DLP lamp when an inactivity time reaches a user defined time period while maintaining power to a main controller board of the DLP television;
turning on the DLP lamp after activity of the DLP television is detected; and
restarting the measurement of the inactivity time.

10. The method according to claim 9, wherein the user defined time period is from about 1 hour to about 24 hours.

11. The method according to claim 9, further comprising measuring an inactivity time of the DLP television and comparing the inactivity time with the user defined time period.

12. The method according to claim 9, further comprising illuminating an LED on the DLP instrument when the lamp is turned off.

13. A digital light processor (DLP) instrument comprising:
a main controller board;
a DLP lamp;
a timer to measure inactivity of the DLP instrument;
a power supply providing continuous power to the main controller board,
wherein the power supply turns off power to the DLP lamp when time measured by the timer reaches a user defined time.

14. The DLP instrument according to claim 13, wherein the timer begins when the DLP instrument is turned on and resets whenever activity is detected with respect to the DLP instrument.

15. The DLP instrument according to claim 13, wherein the user defined time is from about 1 hour to about 24 hours.

16. The DLP instrument according to claim 13, further comprising an LED light illuminated when the power is turned off to the DLP lamp and when power is turned on to the main controller board.

17. The DLP instrument according to claim 13, further comprising an integrated tuner, wherein power is continuously supplied to the tuner regardless of whether power is supplied to the DLP lamp.
